(19) United States
(12) Patent Application Publication
(10) Pub. No.: US 2018/0075943 A1
(43) Pub. Date: Mar. 15, 2018

(54) EXTERIOR WIRING HARNESS AND HARNESS-EQUIPPED ELECTRICAL DEVICE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Ryouya Okamoto, Yokkaichi, Mie (JP); Hiroki Hirai, Yokkaichi, Mie (JP); Tetsuji Tanaka, Yokkaichi, Mie (JP); Hiroomi Hiramitsu, Yokkaichi, Mie (JP); Hiroshi Shimizu, Yokkaichi, Mie (JP); Hitoshi Takeda, Yokkaichi, Mie (JP)

(21) Appl. No.: 15/559,930

(22) PCT Filed: Mar. 16, 2016
(86) PCT No.: PCT/JP2016/058300

§ 371 Date: Sep. 20, 2017

(30) Foreign Application Priority Data
Mar. 31, 2015 (JP) 2015-071802

(51) Int. Cl. H01B 7/00; H01B 3/48; H01G 11/08; H01M 2/22; H01M 10/48

(52) U.S. Cl. CPC H01B 7/0045; H01B 3/48; H02G 3/08; H01M 2/22; H01M 10/48; H01G 11/08

(57) ABSTRACT

It is aimed to provide an exterior wiring harness for which a routing space is simplified and reduced in size. An exterior wiring harness (10) is disposed on an outer surface of a power storage module (20). The exterior wiring harness (10) includes a plurality of wires (11), and an exterior body (12) formed by surrounding outer peripheries of the plurality of wires (11) by a sheet (13) made of fibrous synthetic resin. The exterior body 12 includes a flat portion 15 having a flat cross-sectional shape, and the flat portion (15) is disposed along at least a part of an outer surface of the power storage module (20).

### BACKGROUND

### Field of the Invention

The invention relates to an exterior wiring harness and a harness-equipped electrical device.

### Description of the Related Art

Japanese Unexamined Patent Publication No. 2009-4323 discloses an electrical device equipped with a wiring harness. This electrical device is a power supply device with a battery assembly including a plurality of batteries. The battery assembly is connected to an electrical connection box, and electrical components are disposed in the electrical connection box. Although not shown in detail, connection is made between the battery assembly and the electrical components or among the plurality of electrical components by a wiring harness. However, the use of the wiring harness for the connection between the battery assembly and the electrical components or among the electrical components complicates the routing of the wiring harness. Thus, it has been required to simplify a routing space for the wiring harness and reduce the size of the routing space.

The invention was completed based on the above situation and aims to provide an exterior wiring harness for which a routing space is simplified and reduced in size, and a harness-equipped electrical device in which this exterior wiring harness is disposed.

### SUMMARY

The invention is directed to an exterior wiring harness with wires, and an exterior body formed by surrounding outer peripheries of the wires by a sheet made of fibrous synthetic resin The exterior body includes a flat portion having a flat cross-sectional shape, and the flat portion is disposed along at least a part of an outer surface of an electrical device

The invention also is directed to a harness-equipped electrical device in which an exterior wiring harness is disposed on an electrical device. The electrical device has at least one outer surface. The exterior wiring harness includes wires and an exterior body formed by surrounding outer peripheries of the wires by a sheet made of fibrous synthetic resin. The exterior body includes a flat portion having a flat cross-sectional shape, and the flat portion is disposed along at least a part of the outer surface of the electrical device.

According to the invention, the flat portion of the exterior wiring harness is disposed along the outer surface of the electrical device. This enables a space expanding near the outer surface of the electrical device to be utilized effectively when routing the plurality of wires. Specifically, the wires can be routed over and along the outer surface of the electrical device so that a routing space can be simplified and reduced in size.

The wires may be aligned side by side inside the flat portion. Thus, wiring can be simplified and the routine space can be utilized effectively by aligning the wires inside the flat portion. Thus, a routing path of the exterior wiring harness can be reduced in size.

The electrical device may be a power storage module with power storage elements. The outer surface of the power storage module may be covered with an exterior body and this exterior body may be formed of a sheet made of fibrous synthetic resin. The outer surface of the power storage module is kept warm by the exterior body. Thus, a reduction in the performance of the power storage module can be suppressed in a low-temperature environment.

The electrical device may include a sounding member for generating a sound at the time of energization or de-energization. A sound generated from the sounding member at the time of energization or de-energization is absorbed by the sheet of the exterior body. In this way, the sound insulation performance of the electrical device can be improved.

The sounding member may be a mechanical relay, and the mechanical relay may include a coil. An input terminal and an output terminal of the coil are connected or separated by flowing a current into this coil or cutting off the current. When being connected, the input terminal and the output terminal may collide to generate a sound. On the other hand, also when the input terminal and the output terminal are separated, at least one of the input terminal and the output terminal may collide with a constituent component (spring, coil or the like) of the mechanical relay. According to this mode, since the exterior wiring harness is disposed on the outer surface of the electrical device, a sound generated from the mechanical relay is absorbed by the exterior body of the exterior wiring harness.

According to the present invention, it is possible to provide an exterior wiring harness for which a routing space is simplified and reduced in size, and a harness-equipped electrical device in which this exterior wiring harness is disposed.

### BRIEF DESCRIPTION OF DRAWINGS

FIG. 1 is a front view of a power storage module according to a first embodiment.

FIG. 2 is a plan view showing the power storage module.

FIG. 3 is a perspective view showing a state where wires are placed on a sheet.

FIG. 4 is a front view showing the state where the wires are placed on the sheet.

FIG. 5 is a front view showing a state where the sheet is folded at a folding portion.

FIG. 6 is a perspective view showing an exterior wiring harness.

FIG. 7 is a plan view showing an electrical connection box according to a second embodiment.

FIG. 8 is a section showing the electrical connection box.

### DETAILED DESCRIPTION

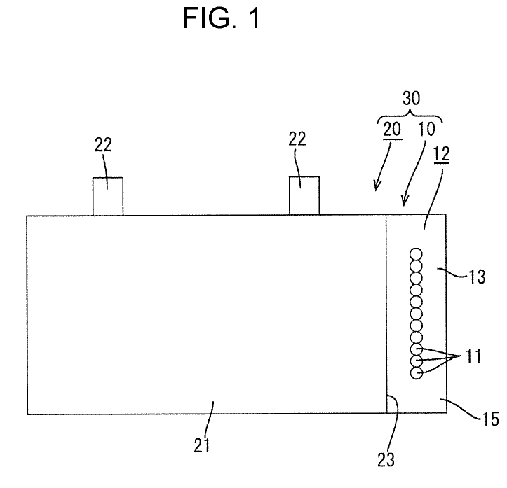

A first embodiment of the invention is described with reference to FIGS. 1 to 6. Note that, in the following description, one member may be denoted with reference sign and the other members may not be denoted with reference sign for a plurality of members having the same shape.

An exterior wiring harness 10 according to this embodiment is disposed in a vehicle (not shown) such as an automotive vehicle, electric vehicle or hybrid vehicle. In the case of disposition in an electric or hybrid vehicle, the exterior wiring harness 10 is used for wiring between a power storage module 20 (an example of an electrical device) serving as a drive source of the electric or hybrid vehicle and an ECU (Electronic Control Unit) for managing and controlling voltages and the like of power storage elements 21 included in this power storage module 20. A harness-equipped power storage module 30 (an example of a harness-equipped electrical device) is formed by disposing the exterior wiring harness 10 on the power storage module 20.

(Power Storage Module 20)

As shown in FIG. 1, the power storage module 20 has a rectangular parallelepiped shape as a whole and the power storage elements 21 are arranged in one direction. Each power storage element 21 has a flat rectangular parallelepiped shape. Two electrode terminals 22 project up on the upper surface of each power storage element 21. Adjacent power storage elements 21 are disposed such that the electrode terminals 22 having mutually different polarities are arranged side by side. The electrode terminals 22 arranged adjacent to each other are electrically connected by unillustrated connecting members made of metal. In this way, the plurality of power storage elements 21 are connected in series.

The power storage element 21 may be a secondary battery such as a nickel hydrogen secondary battery, a lithium-ion secondary battery or a lead-acid battery or may be a capacitor such as an electrical double layer capacitor or a lithium-ion capacitor.

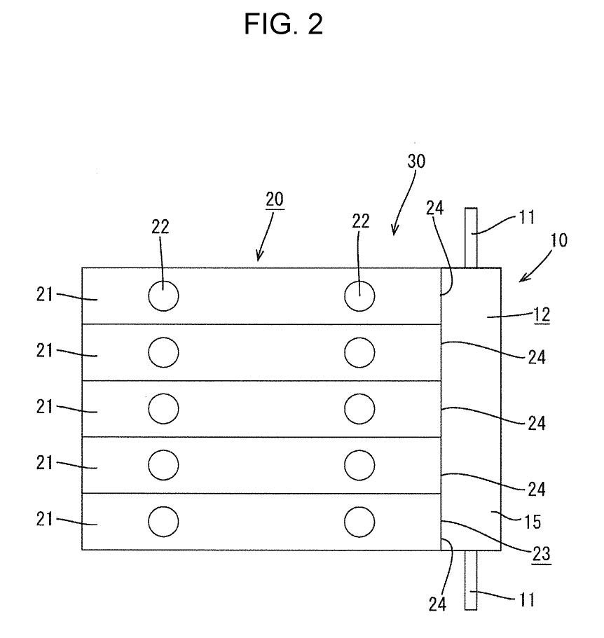

As shown in FIG. 2, the exterior wiring harness 10 is disposed on and along a side surface 23 (an example of an outer surface) on which side surfaces 24 of the power storage elements 21 are arranged, out of side surfaces of the power storage module 20. The exterior wiring harness 10 is designed to contact the side surfaces 24 of the plurality of power storage elements 21.

(Exterior Wiring Harness 10)

As shown in FIG. 1, the exterior wiring harness 10 includes wires 11 and an exterior body 12 surrounding the wires 11. The outer peripheries of the wires 11 are surrounded by the exterior body 12 formed of a sheet 13 made of fibrous synthetic resin. Each wire 11 has a circular cross-section and includes a core (not shown) and an insulation coating (insulation layer) covering around the core. The core is made of copper, copper alloy or aluminum alloy and, for example, a twisted wire obtained by twisting a plurality of metal strands or a single-core wire.

A thickness of the sheet 13 is set at a thickness necessary to maintain the temperature of each power storage element 21 at a temperature higher than a temperature necessary to maintain the performance of the power storage module 20. This thickness is appropriately set according to a material. For example, aramid fibers, glass fibers, cellulose fibers, nylon fibers, vinylon fibers, polyester fibers, polyolefin fibers, rayon fibers and the like can be used as the material of the sheet 13.

Synthetic resin which can be partially or entirely melted or softened through a heating process and, thereafter, cured through a cooling process can be used as synthetic resin constituting the sheet 13. Synthetic resin containing base fibers and adhesive resin (also called binder) can be used as such synthetic resin. The adhesive resin is resin having a lower melting point than the base fibers. By heating the sheet 13 to a temperature lower than the melting point of the base fibers and higher than the melting point of the adhesive resin, the adhesive resin is melted to infiltrate between the base fibers. Thereafter, when the temperature of the sheet 13 decreases, the adhesive resin is solidified. In this way, the sheet 13 can be maintained in a molded state during heating. Here, the sheet 13 (also called nonwoven fabric) formed into a sheet-like shape is used.

The base fibers of the sheet 13 only have to maintain a fibrous state at the melting point of the adhesive resin and various fibers can be used besides resin fibers. Further, thermoplastic resin fibers having a melting point lower than that of the base fibers can be used as the adhesive resin. For example, a combination of the base fibers and the adhesive resin is a combination of PET (polyethylene terephthalate) resin fibers as the base fibers and copolymer resin of PET and PEI (polyethylene isophthalate) as the adhesive resin.

The exterior body 12 includes a flat portion 15 having a flat cross-sectional shape in a plane perpendicular to an extending direction of the wires 11. The flat portion 15 may be cured by being heated. Even if being heated, the flat portion 15 may be in a semi-cured state having a degree of softness to be bendable. Further, the flat portion 15 may be freely bendable by being not heated.

The cross-sectional shape of the flat portion 15 can be a rectangular shape (excluding a square shape), an oval shape, an elliptical shape or any arbitrarily shape if necessary. Further, the rectangular shape may have chamfered ridges or rounded ridges.

The wires 11 are aligned side by side inside the flat portion 15. In other words, the wires 11 are arranged in a direction intersecting with the extending direction of each wire 11.

The wires 11 of the exterior wiring harness 10 may be connected electrically to the electrode terminals 22 of the power storage module 20 or may be connected electrically to an electrical device different from the power storage module 20.

In this embodiment, the exterior wiring harness 10 entirely covers one side surface 23 of the power storage module 20 on this side surface 23. As described above, the side surfaces 24 of the power storage elements 21 are arranged on this side surface 23. In this way, the exterior wiring harness 10 is disposed to cover the entire side surfaces 24 of the respective power storage elements 21.

The power storage module 20 and the exterior wiring harness 10 are fixed by a known method, such as screwing, adhesion, riveting or clipping.

(Manufacturing Process of Embodiment)

Next, the exterior wiring harness 10 according to this embodiment and an example of a manufacturing process of the power storage module 20 using the exterior wiring harness 10 are described. Note that the manufacturing process of this embodiment is not limited to the following process.

(External Wiring Harness 10)

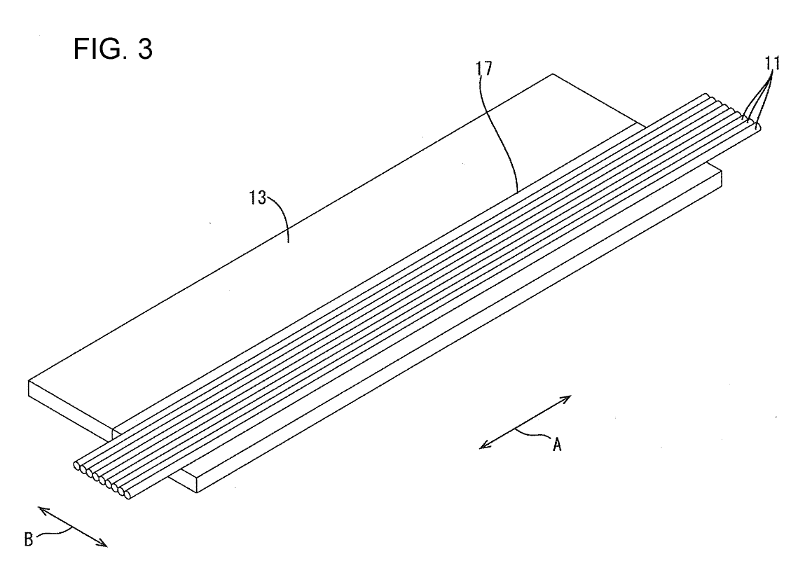

FIGS. 3 to 6 show an example of a manufacturing process of the flat portion 15. First, as shown in FIG. 3, the sheet 13 is placed and the wires 11 are placed on the sheet 13. The sheet 13 is disposed such that a longitudinal direction thereof is aligned with the extending direction of the wires 11 (directions shown by arrows A in FIG. 3). The sheet 13 includes a folding portion 17 extending along the longitudinal direction (extending direction of the wires 11) at a position near a center in a direction (directions shown by arrows B in FIG. 3) intersecting with the longitudinal direction (extending direction of the wires 11)

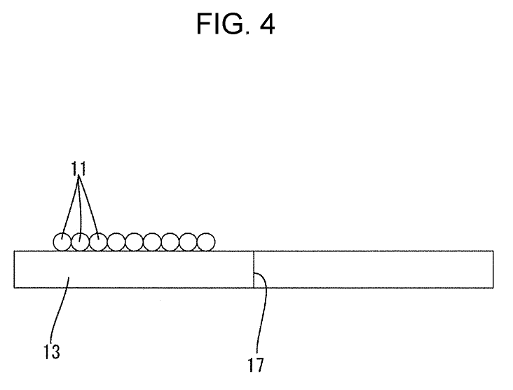

As shown in FIG. 4, the folding portion 17 is folded with the wires 11 placed on the sheet 13. Then, the wires 11 are sandwiched from upper and lower sides and surrounded by the sheet 13 folded at the folding portion 17.

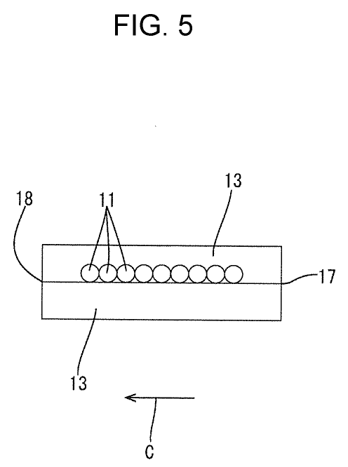

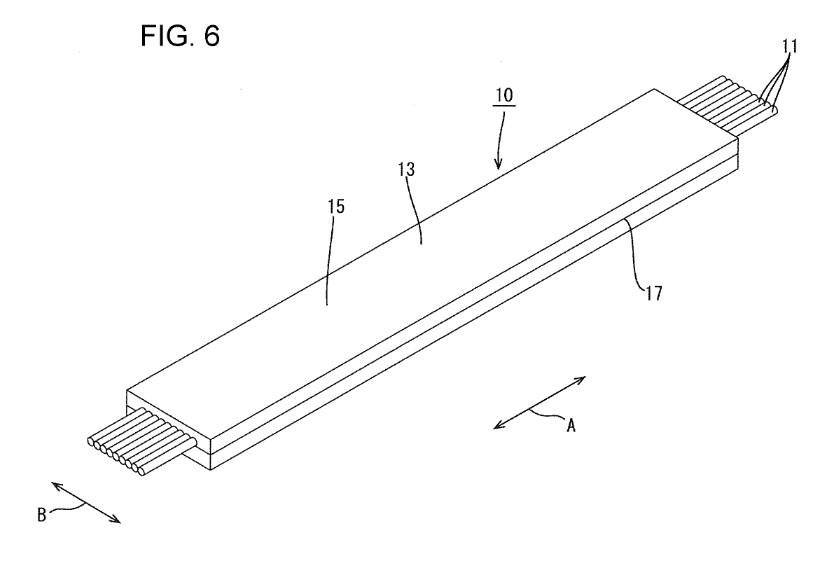

Subsequently, end parts of the sheet 13 in a folding direction (direction shown by an arrow C in FIG. 5) are overlapped and joined to each other so that the wires 11 are surrounded (see FIG. 6). In other words, end parts of the sheet 13 located on a side opposite to the folding portion 17 in the direction intersecting with the longitudinal direction (extending direction of the wires 11) and overlapping one above the other are joined by a known method such as thermal fusion, adhesion, metal riveting or resin riveting. A part of the sheet 13 where the end parts are joined to each other serves as a joined portion 18.

Thermal fusion may be performed by sandwiching the overlapped end parts of the sheet 13 from upper and lower sides by a pair of tools and heating upper and lower end parts or may be performed by applying ultrasonic vibration by a pair of tools.

Further, the sheet 13 may be hot-pressed in a state folded at the folding portion 17 by being sandwiched from upper and lower sides by a pair of molds (not shown). In this case, the sheet 13 is set in the semi-cured state by adjusting a heating temperature, a heating time or the like. The semi-cured state means that the flat portion 15 has a degree of hardness to be bendable. (Power Storage Module 20)

The power storage elements 21 are arranged in one direction such that adjacent electrode terminals 22 have different polarities. Subsequently, the electrode terminals 22 of the power storage elements 21 are electrically connected by the connecting members.

The flat portion 15 of the exterior wiring harness 10 then is disposed along the side surface 23 of the power storage module 20 and the power storage module 20 and the exterior wiring harness 10 are fixed by a known method, such as screwing. In this embodiment, the flat portion 15 is disposed to cover the entire side surface 23 of the power storage module 20.

### Functions and Effects of Embodiment

Next, functions and effects of this embodiment are described. The exterior wiring harness 10 according to this embodiment includes the wires 11, the exterior body 12 formed by surrounding the outer peripheries of the wires 11 by the sheet 13 made of fibrous synthetic resin. The exterior body 12 includes the flat portion 15 having a flat cross-sectional shape, and the flat portion 15 is disposed along at least a part of the side surface 23 of the electrical device.

The harness-equipped power storage module 30 according to this embodiment has the exterior wiring harness 10 disposed on the power storage module 20. The power storage module 20 has at least one side surface 23. The exterior wiring harness 10 includes the wires 11 and the exterior body 12 formed by surrounding the outer peripheries of the wires 11 by the sheet 13 made of fibrous synthetic resin. The exterior body 12 includes the flat portion 15 having a flat cross-sectional shape, and the flat portion 15 is disposed along at least a part of the side surface 23 of the power storage module 20.

According to this embodiment, the flat portion 15 of the exterior wiring harness 10 is disposed along the side surface 23 of the power storage module 20. This enables a space expanding near the side surface 23 of the power storage module 20 to be utilized effectively when routing the wires 11. Specifically, since the wires 11 can be routed over and along the side surface 23 of the power storage module 20, a routing space can be reduced in size.

Further, since the wires 11 are aligned side by side inside the flat portion 15 according to this embodiment, wiring can be simplified and the routine space can be utilized effectively utilized

Further, according to this embodiment, the side surface 23 of the power storage module 20 is covered by the exterior body 12 and this exterior body 12 is formed of the sheet 13 made of fibrous synthetic resin. The side surface 23 of the power storage module 20 is kept warm by the exterior body 12. Thus, a reduction in the performance of the power storage module 20 can be suppressed also in a low-temperature environment.

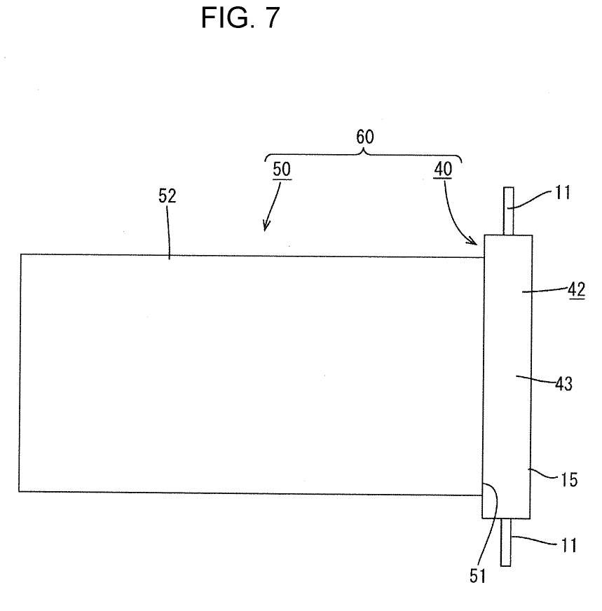

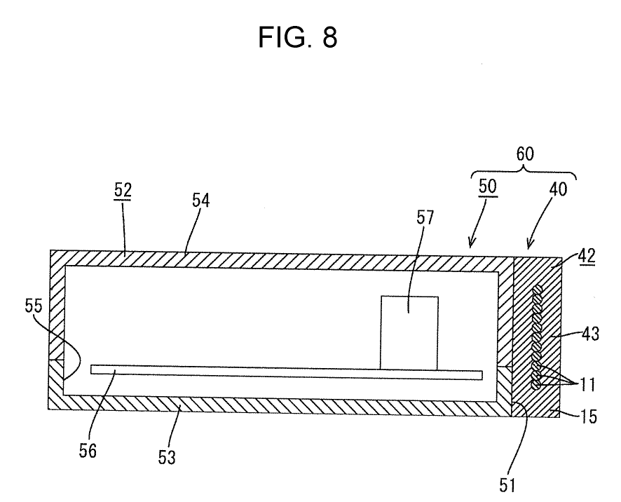

A second embodiment is described with reference to FIGS. 7 and 8. As shown in FIG. 7, an exterior wiring harness 40 according to this embodiment is disposed along a side surface 51 of an electrical connection box 50 (an example of an electrical device). A harness-equipped electrical connection box 60 (an example of a harness-equipped electrical device) is formed by disposing the exterior wiring harness 40 on the electrical connection box 50. The electrical connection box 50 is disposed in an unillustrated battery pack and electrically connected to a power storage module 20 including a plurality of power storage elements 21, and energizes and de-energizes the power storage module 20.

As shown in FIG. 8, the electrical connection box 50 has a circuit board 56 is accommodated in a case 52. The case 52 includes a lower case 53 having an opening, and an upper case 54 shaped in conformity with the shape of the opening of the lower case 53 and configured to close the opening 55 of the lower case 53. The lower case 53 and the upper case 54 are assembled by a known method, such as screwing or resilient engagement between a lock portion and a locked portion.

The circuit board 56 is formed with an unillustrated conductive path by a known printed wiring technique. A mechanical relay (an example of a sounding member) is electrically connected to this conductive path by a known method such as soldering.

The mechanical relay 57 includes an unillustrated coil. An input terminal (not shown) and an output terminal (not shown) are connected or separated by flowing a current into this coil or cutting off the current. The input terminal and the output terminal may collide when being connected and the collision may generate a sound. On the other hand, at least one of the input terminal and the output terminal may collide with a constituent component (spring, coil or the like) of the mechanical relay 57 when being separated.

The exterior wiring harness 40 is disposed on the side surface 51 of the case 52 relatively close to the mechanical relay 57. This causes a sound generated from the mechanical relay 57 to be absorbed by the exterior body 42 of the exterior wiring harness 40.

A thickness of a sheet 43 of the exterior body 42 is such a thickness as to be able to suppress a collision sound or the like between the input terminal and the output terminal in the mechanical relay 57 to a level not felt uncomfortable by a user.

Since the configuration other than the above is substantially the same as in the first embodiment, the same members are denoted by the same reference signs and repeated description is omitted.

The invention is not limited to the above described and illustrated embodiments. For example, the following embodiments are also included in the technical scope of the present invention.

Although the power storage elements 21 are connected in series in the first embodiment, there is no limitation to this and the power storage elements 21 may be connected in parallel or some of the plurality of power storage elements 21 may be connected in series and the others may be connected in parallel.

Although the exterior wiring harness 10 is disposed on one outer surface of the power storage module 20 in the first embodiment, there is no limitation to this and the exterior wiring harness 10 may be disposed on two, three or four outer surfaces of the power storage module 20. Further, depending on the shape of the power storage module 20, the exterior wiring harness 10 may be disposed on five or more outer surfaces.

Although the exterior wiring harness 40 is arranged on the side surface 51 of the electrical connection box 50 in the second embodiment, there is no limitation to this and the exterior wiring harness 40 can be disposed on a side surface of an arbitrary electrical device which generates a sound at the time of energization such as a blower or motor.

Although the exterior wiring harness 40 is arranged on one side surface of the electrical connection box 50 in the second embodiment, there is no limitation to this and the exterior wiring harness 40 may be disposed on two, three or four outer surfaces of the electrical connection box 50. Further, depending on the shape of the electrical connection box 50, the exterior wiring harness 40 may be disposed on five or more outer surfaces.

Although only the shape of the flat portion 15 is described as the shape of the exterior wiring harness in the above embodiments, there is no limitation to this and the exterior wiring harness may include a part whose cross-section has a polygonal shape such as a triangular or pentagonal shape, a circular shape, an elliptical shape, an oval shape or any arbitrary shape if necessary.

Although the exterior wiring harness is configured to cover one entire side surface of the electrical device in the above embodiments, there is no limitation to this and the exterior wiring harness may be configured to cover a part of one side surface of the electrical device.

### LIST OF REFERENCE SIGNS

10, 40: exterior wiring harness
11: wire
12, 42: exterior body
13, 43: sheet
15: flat portion
20: power storage module
23, 51: side surface
30: harness-equipped power storage module
50: electrical connection box
57: mechanical relay
60: harness-equipped electrical connection box

1. An exterior wiring harness, comprising:
a plurality of wires; and
an exterior body formed by surrounding outer peripheries of the plurality of wires by a sheet made of fibrous synthetic resin,
wherein:
the exterior body includes a flat portion having a flat cross-sectional shape; and
the flat portion is disposed along at least a part of an outer surface of device power storage module including power storage elements.

2. The exterior wiring harness of claim 1, wherein the plurality of wires are aligned side by side inside the flat portion.

3. A harness-equipped electrical device in which an exterior wiring harness is disposed on an electrical device, wherein:
the electrical device is a power storage module having at least one outer surface and including power storage elements;
the exterior wiring harness includes a plurality of wires, and an exterior body formed by surrounding outer peripheries of the plurality of wires by a sheet made of fibrous synthetic resin;
the exterior body includes a flat portion having a flat cross-sectional shape; and
the flat portion is disposed along at least a part of the outer surface of the power storage module.

4. The harness-equipped electrical device of claim 3, wherein the plurality of wires are aligned side by side inside the flat portion.

5. (canceled)

6. The harness-equipped electrical device of claim 3, wherein the electrical device includes a sounding member for generating a sound at the time of energization or de-energization.

7. The harness-equipped electrical device of claim 6, wherein the sounding member is a mechanical relay.

8. The harness-equipped electrical device of claim 3, wherein the electrical device includes a sounding member for generating a sound at the time of energization or de-energization.

9. The harness-equipped electrical device of claim 8, wherein the sounding member is a mechanical relay.
